(19) United States
(12) Patent Application Publication
(10) Pub. No.: US 2020/0234633 A1
(43) Pub. Date: Jul. 23, 2020

(54) PIXEL DRIVING CIRCUIT AND OPERATING METHOD THEREOF, AND DISPLAY PANEL

(71) Applicants: BEIJING BOE OPTOELECTRONICS TECHNOLOGY CO., LTD., BEIJING (CN); BOE TECHNOLOGY GROUP CO., LTD., BEIJING (CN)

(72) Inventors: Xin WANG, Beijing (CN); Ying LIU, Beijing (CN)

(21) Appl. No.: 16/089,875

(22) PCT Filed: Mar. 30, 2018
(86) PCT No.: PCT/CN2018/081332

§ 371 Date: Sep. 28, 2018

(30) Foreign Application Priority Data
Apr. 17, 2017 (CN) 201710249921.5

(51) Int. Cl. G09G 3/325; G09G 3/3266

(52) U.S. Cl. CPC G09G 3/325; G09G 2320/0247; G09G 3/3266

(57) ABSTRACT

A pixel driving circuit is provided that comprises: a pixel compensation circuit comprising a driving transistor for driving a light-emitting device in a pixel and an initialization transistor, a first pole of the initialization transistor being coupled to an initialization signal terminal for receiving an initialization signal, a second pole of the initialization transistor being coupled to a control electrode of the driving transistor; a signal input sub-circuit coupled between a reset signal terminal and a control electrode of the initialization transistor, for selectively providing a reset signal, which is received from the reset signal terminal, to the control electrode of the initialization transistor under control of the reset signal; a leakage suppression sub-circuit respectively coupled to a leakage control signal terminal and the control electrode of the initialization transistor, the leakage suppression sub-circuit being configured so that: the leakage suppression sub-circuit is charged or discharged by a leakage control signal received from the leakage control signal terminal, and the initialization transistor is turned off by the charging or discharging.

### CROSS-REFERENCE TO RELATED APPLICATIONS

The present application claims priority to Chinese Patent Application No. 201710249921.5 filed on Apr. 17, 2017, which is hereby incorporated in its entirety by reference.

### TECHNICAL FIELD

The present disclosure relates to the field of display technologies, and in particular, to a pixel driving circuit, an operating method thereof, and a display panel.

### BACKGROUND

Organic Light-emitting Diode (OLED) is one of the hotspots in the field of flat panel display. Compared with liquid crystal displays (LCDs), OLED displays have the advantages of low energy consumption, low production cost, self-illumination, wide viewing angle and fast response. Conventionally, in the display fields of mobile phones, tablets, digital cameras, etc., OLED displays have begun to replace traditional LCD displays. But unlike LCDs that use a stable voltage to control brightness, OLEDs are current-driven and require a constant current to control their illumination. In consideration of process variations and device aging, etc., a pixel compensation circuit having a function of compensating for the threshold voltage Vth of the driving transistor is generally used as a driving circuit to drive the OLED to emit light.

Conventionally, an initialization transistor is also provided in the pixel compensation circuit generally, to receive an initialization signal, supply the initialization signal to the gate of the driving transistor at a phase after the completion of OLED illumination driven by the driving transistor, and initialize the gate voltage of the driving transistor. In the remaining phases of operation of the pixel compensation circuit, the initialization transistor is turned off. In particular, the initialization transistor may need to be guaranteed to be in an off state during the illumination phase in which the driving transistor drives the OLED to emit light. For the initialization transistor, generally a switch transistor is used to implement the switching function. However, it may be hard for the switch transistor to guarantee lossless conduction or complete turn-off, thus a leakage current path may be formed in the switch transistor, causing some current for OLED illumination to flow into the initialization signal path through the initialization transistor, thereby affecting the luminescence brightness of the OLED, which may in turn cause flicker.

### SUMMARY

Some embodiments of the present disclosure provide a pixel driving circuit, a method of operating the same, and a display panel. According to the embodiments of the present disclosure, it is possible to avoid formation of a leakage current path with the initialization transistor, improve the luminance of the OLED, and/or improve or eliminate the flicker phenomenon during display.

According to an aspect of the present disclosure, a pixel driving circuit is provided that comprises: a pixel compensation circuit comprising a driving transistor for driving a light-emitting device in a pixel and an initialization transistor, a first pole of the initialization transistor being coupled to an initialization signal terminal for receiving an initialization signal, a second pole of the initialization transistor being coupled to a control electrode of the driving transistor; a signal input sub-circuit coupled between a reset signal terminal and a control electrode of the initialization transistor, for selectively providing a reset signal, which is received from the reset signal terminal, to the control electrode of the initialization transistor under control of the reset signal; a leakage suppression sub-circuit respectively coupled to a leakage control signal terminal and the control electrode of the initialization transistor, the leakage suppression sub-circuit being configured so that: the leakage suppression sub-circuit is charged or discharged by a leakage control signal received from the leakage control signal terminal, and the initialization transistor is turned off by the charging or discharging.

In an embodiment, the leakage suppression sub-circuit is further configured to: changing the voltage difference between the control electrode of the initialization transistor and the second pole of the initialization transistor under control of the leakage control signal to cause the initialization transistor to be further turned off.

In an embodiment, the initialization transistor is an N-type transistor, and wherein the changing comprises: reducing the voltage difference between the control electrode of the initialization transistor and the second pole of the initialization transistor.

In an embodiment, the initialization transistor is a P-type transistor, and wherein the changing comprises increasing the voltage difference between the control electrode of the initialization transistor and the second pole of the initialization transistor.

In an embodiment, the leakage control signal comprises a pulse signal including a high level period and a low level period in each pulse cycle of the pulse signal; wherein the leakage suppression sub-circuit is configured to: charge the leakage suppression sub-circuit by the high level period of the pulse signal, and discharge the leakage suppression sub-circuit by the low level period of the pulse signal, wherein in the pulse cycle, the duration of the low level period for discharging is less than that of the high level period for charging.

In an embodiment, the leakage control signal comprises a pulse signal including a high level period and a low level period in each pulse cycle of the pulse signal; wherein the leakage suppression sub-circuit is configured to: charge the leakage suppression sub-circuit by the high level period of the pulse signal, and discharge the leakage suppression sub-circuit by the low level period of the pulse signal, wherein in the pulse cycle, the duration of the low level period for discharging is greater than that of the high level period for charging.

In an embodiment, the signal input sub-circuit comprises: a first switch transistor, wherein a control electrode and a first pole of the first switch transistor are both coupled to the reset signal terminal, and a second pole of the first switch transistor is coupled to the control electrode of the initialization transistor.

In an embodiment, the first switch transistor has an active layer comprising polysilicon.

In an embodiment, the leakage suppression sub-circuit comprises: a first capacitor, wherein the first capacitor has a first terminal coupled to the leakage control signal terminal and a second terminal coupled to the control electrode of the initialization transistor.

In an embodiment, the pixel compensation circuit further comprises a data write sub-circuit, a reset sub-circuit, a compensation control sub-circuit, a storage sub-circuit, and an illumination control sub-circuit; wherein the first pole of the driving transistor is coupled to a first power terminal; wherein the data write sub-circuit is respectively coupled to a data signal terminal, a scan signal terminal and a first node, for providing a data signal provided at the data signal terminal to the first node under control of a scanning signal provided at the scan signal terminal; wherein the reset sub-circuit is respectively coupled to the reset signal terminal, the reference signal terminal, and the first node, for providing a reference signal provided at the reference signal terminal to the first node under control of the reset signal; wherein the compensation control sub-circuit is respectively coupled to the scan signal terminal, the control electrode of the driving transistor, and the second pole of the driving transistor, for electrically coupling the control electrode of the driving transistor to the second pole of the driving transistor under control of the scanning signal; wherein the storage sub-circuit is respectively coupled to the first node and the control electrode of the driving transistor, for being charged or discharged under control of the signal at the first node and the signal at the control electrode of the driving transistor and maintaining a voltage difference between the first node and the control electrode of the driving transistor stable when the control electrode of the driving transistor is in a floating state; and wherein the illumination control sub-circuit is respectively coupled to the illumination control signal terminal, the reference signal terminal, the first node, the second pole of the driving transistor, and the first terminal of the light-emitting device, for under control of an illumination control signal provided at the illumination control signal terminal, electrically connecting the reference signal terminal to the first node and electrically connecting the second pole of the driving transistor and the first terminal of the light-emitting device such that the driving transistor is capable of driving the light-emitting device to emit light.

In an embodiment, the data write sub-circuit comprises a second switch transistor having a control electrode coupled to the scan signal terminal, a first pole coupled to the data signal terminal, and a second pole coupled to the first node; wherein the reset sub-circuit comprising a third switch transistor having a control electrode coupled to the reset signal terminal, a first pole coupled to the reference signal terminal, and a second pole coupled to the first node; wherein the compensation control sub-circuit comprises a fourth switch transistor having a control electrode coupled to the scan signal terminal, a first pole coupled to the control electrode of the driving transistor, and a second pole coupled to the second pole of the driving transistor; wherein the storage sub-circuit comprises a second capacitor having a first terminal coupled to the first node and a second terminal coupled to the control pole of the driving transistor; and wherein the illumination control sub-circuit comprises a fifth switch transistor and a sixth switch transistor; wherein a control electrode of the fifth switch transistor is coupled to the illumination control signal terminal, a first pole of the fifth switch transistor coupled to the reference signal terminal, and a second pole of the fifth switch transistor is coupled to the first node; a control pole of the sixth switch transistor is coupled to the illumination control signal terminal, a first pole of the sixth switch transistor is coupled to the second pole of the driving transistor, and a second pole of the sixth switch transistor is coupled to the first terminal of the light-emitting device.

In an embodiment, in the case where the driving transistor is a P-type transistor, each of the switch transistor(s) in one or more of the data write sub-circuit, the reset sub-circuit, the compensation control sub-circuit, the storage sub-circuit, and the illumination control sub-circuit is configured by a P-type transistor.

In an embodiment, in the case where the driving transistor is an N-type transistor, each of the switch transistor(s) in one or more of the data write sub-circuit, the reset sub-circuit, the compensation control sub-circuit, the storage sub-circuit, and the illumination control sub-circuit It is configured by an N-type transistor.

According to another aspect of the present disclosure, there is provided a display device comprising: a light-emitting device, and a pixel driving circuit according to any of the embodiment of the present disclosure for driving the light-emitting device.

According to a further aspect of the present disclosure, there is provided an operating method for a pixel driving circuit of claim 1, the method comprising: in a data writing phase, configuring the reset signal to turn the signal input sub-circuit off, charging the leakage suppression sub-circuit by the leakage control signal to turn off the initialization transistor, and changing a voltage difference between the control electrode of the initialization transistor and the second pole of the initialization transistor by the leakage suppression sub-circuit under control of the leakage control signal; in the light-emitting phase, keeping the signal input sub-circuit off by the reset signal, maintaining the charging of the leakage suppression sub-circuit by the leakage control signal to further turn off the initialization transistor; and driving, by the driving transistor, the light-emitting device to emit light.

In an embodiment, the initialization transistor is an N-type transistor, and the changing comprises: reducing the voltage difference between the control electrode of the initialization transistor and the second pole of the initialization transistor.

In an embodiment, the initialization transistor is a P-type transistor, and the changing comprises: increasing the voltage difference between the control electrode of the initialization transistor and the second pole of the initialization transistor.

In an embodiment, the leakage control signal comprises a pulse signal including a high level period and a low level period in each pulse cycle of the pulse signal; wherein reducing the voltage difference comprises: charging the leakage suppression sub-circuit by the high level period of the pulse signal, and discharging the leakage suppression sub-circuit by the low level period of the pulse signal, wherein in the pulse cycle, the duration of the low level period for discharging is less than the high level period for charging.

In an embodiment, the leakage control signal comprises a pulse signal including a high level period and a low level period in each pulse cycle of the pulse signal; wherein increasing the voltage difference comprises: charging the leakage suppression sub-circuit by the high level period of the pulse signal, and discharging the leakage suppression sub-circuit by the low level period of the pulse signal, wherein in the pulse cycle, the duration of the low level period for discharging is greater than the high level period for charging.

In an embodiment, the pixel compensation circuit further comprises a data write sub-circuit, a reset sub-circuit, a compensation control sub-circuit, a storage sub-circuit, and an illumination control sub-circuit; the first pole of the driving transistor is coupled to the first power terminal; the data write sub-circuit is respectively coupled to the data signal terminal, the scan signal terminal and the first node; the reset sub-circuit is respectively coupled to the reset signal terminal, the reference signal terminal, and the first node; the compensation control sub-circuit is respectively coupled to the scan signal terminal, the control electrode of the driving transistor, and the second pole of the driving transistor; the storage sub-circuit is respectively coupled to the first node and the control electrode of the driving transistor; the light-emitting control sub-circuit is respectively coupled to the light-emitting control signal terminal, the reference signal terminal, the first node, and the second pole of the driving transistor, and the first terminal of the light-emitting device, the method further comprises: in the initialization phase, providing the reset signal to the control electrode of the initialization transistor by the signal input sub-circuit under control of the reset signal; providing the reference signal provided at the reference signal terminal to the first node by the reset sub-circuit under control of the reset signal; and discharging the storage sub-circuit under control of a signal at the first node and a signal at the control electrode of the driving transistor.

In an embodiment, the method further comprises: in the data writing phase, providing the data signal to the first node by the data write sub-circuit under control of the scan signal; electrically connecting the control electrode of the driving transistor and the second pole of the driving transistor by the compensation control sub-circuit under control of the scan signal; and charging the storage sub-circuit under control of the signal at the first node and the signal at the control pole of the driving transistor.

### BRIEF DESCRIPTION OF DRAWINGS

FIG. 1 is a block diagram showing the structure of a pixel driving circuit according to some embodiments of the present disclosure;

FIG. 2 is a schematic structural diagram of a pixel driving circuit according to some embodiments of the present disclosure;

FIG. 3a illustrates a detailed structural diagram of a pixel driving circuit according to some embodiments of the present disclosure; FIG.

FIG. 3b illustrates a detailed structural diagram of a pixel driving circuit according to some embodiments of the present disclosure; FIG.

FIG. 4a shows a detailed structural diagram of a pixel driving circuit in accordance with some embodiments of the present disclosure;

FIG. 4b illustrates a detailed structural diagram of a pixel driving circuit in accordance with some embodiments of the present disclosure;

FIG. 5a is a timing diagram schematically showing the operation of the pixel driving circuit shown in FIG. 3a;

FIG. 5b is a timing diagram schematically showing the operation of the pixel driving circuit shown in FIG. 4a;

FIG. 6 is a flow chart of a method of operation of a pixel driving circuit in accordance with some embodiments of the present disclosure;

FIG. 7 is a flow chart of a method of operation of a pixel driving circuit in accordance with some embodiments of the present disclosure;

FIGS. 8a and 8b are flow diagrams showing some additional steps of a method of operating a pixel driving circuit in accordance with some embodiments of the present disclosure.

### DETAILED DESCRIPTION OF EXEMPLARY EMBODIMENTS

For clearly understanding of the objectives, technical solutions, and advantages of the present disclosure, the embodiments and the specific implementations of the present disclosure are described in detail below with reference to the accompanying drawings. The preferred embodiments described below are intended to describe and explain the present disclosure only, and not for limit the disclosure. And in the case there is no conflict, the embodiments in the present application and the features in the embodiments can be combined with each other.

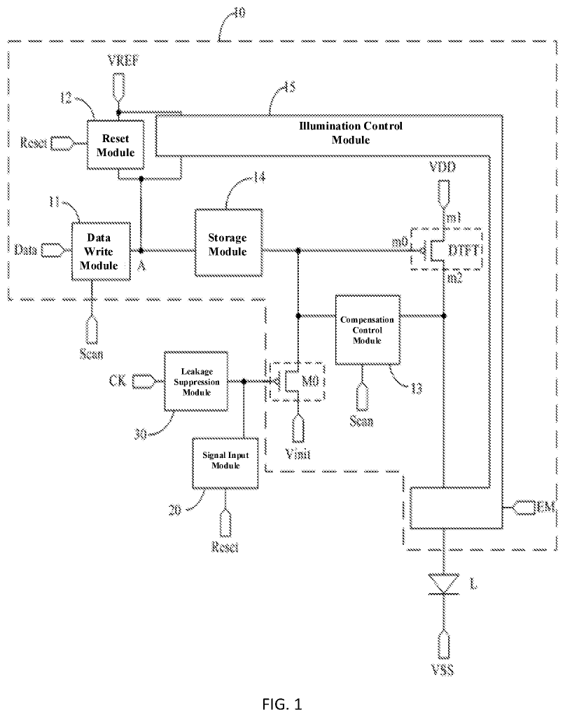

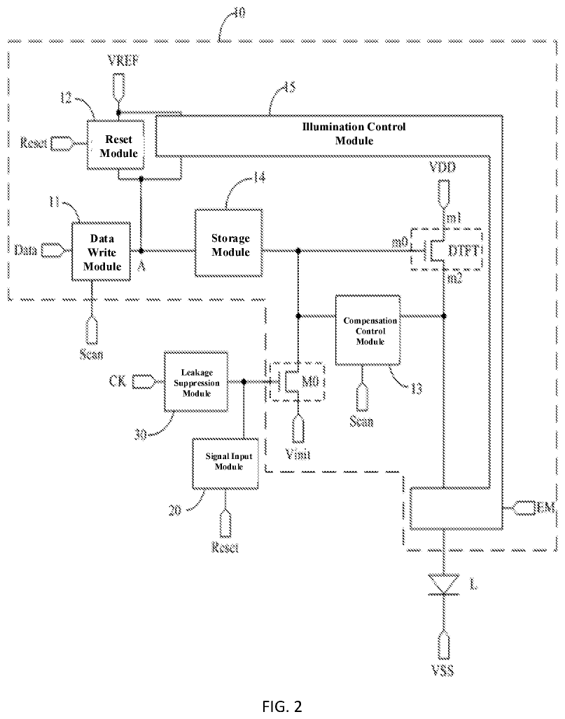

Some embodiments of the present disclosure provide a pixel circuit, as shown in FIGS. 1 and 2, which may include a light-emitting device L (such as, but not limited to, an OLED) and a pixel driving circuit for driving the light-emitting device L. Also shown in FIGS. 1 and 2 is a block diagram showing the structure of a pixel driving circuit in accordance with some embodiments of the present disclosure. The main difference between FIG. 1 and FIG. 2 is that different types of transistors are used, and therefore, the following description will be collectively described in conjunction with the two figures.

As shown in FIGS. 1 and 2, the pixel driving circuit may include a pixel compensation circuit 10. The pixel compensation circuit 10 may include a driving transistor DTFT and an initialization transistor M0. The control electrode (e.g., the gate) of the initialization transistor M0 is coupled to a reset signal terminal Reset. The first pole (for example, the source or the drain) of the initialization transistor M0 is coupled to an initialization signal terminal (i.e., first signal terminal) Vinit. The second pole (e.g., the drain or the source) of the initialization transistor M0 is coupled to the control electrode (e.g., gate) of the driving transistor DTFT. In the embodiment shown in FIG. 1, the initialization transistor M0 and the driving transistor DTFT can be implemented using P-type transistors (for example, P-type MOS transistors). In the embodiment shown in FIG. 2, the initialization transistor M0 and the driving transistor DTFT can be implemented using N-type transistors (for example, N-type MOS transistors).

It will be readily understood by those skilled in the art that in the case where the initialization transistor M0 and the driving transistor DTFT are implemented using different types of transistors, other modules, components or elements, etc., can be adaptively adjusted or changed to practice the principles and embodiments of the present disclosure. For example, the other modules, components or components can be implemented using appropriate types of transistors accordingly. It should also be understood that the electrode of the transistor that is not the control electrode (such as the drain or the source, also referred to as the non-control electrode) is herein referred to as the “first pole” or “second pole”, and the use of the term is not limiting and is just to distinguish it from the control electrode. It should also be understood that for MOS transistors, generally the source and drain are interchangeable.

As shown in FIG. 1 and FIG. 2, the pixel driving circuit may further include: a signal input module 20 and a leakage suppression module 30. As shown in FIG. 1 and FIG. 2, the reset signal terminal (i.e., second signal terminal) Reset can be coupled to the control electrode of the initialization transistor M0 through the signal input module 20. The signal input module 20 can be configured to selectively provide a reset signal provided at the reset signal terminal Reset to the control electrode of the initialization transistor M0 under control of a reset signal (i.e., second signal) provided at the reset signal terminal Reset.

As shown in FIGS. 1 and 2, the leakage suppression module 30 can be coupled to a leakage control signal terminal (i.e., third signal terminal) CK and the control electrode of the initialization transistor M0, respectively. An end of the leakage suppression module 30 may be coupled to the leakage control signal terminal (i.e., third signal terminal) CK to receive a leakage control signal (i.e., third signal, also indicated by CK), and the other end may be coupled to the control electrode of the initialization transistor M0. The leakage suppression module 30 can be configured to: charge or discharge the leakage suppression module with the leakage control signal, and cause the initialization transistor to be turned off by the charging or discharging, which will be further described below.

In some embodiments of the present disclosure, as shown in FIG. 1 and FIG. 2, the pixel compensation circuit 10 may further include: a data write module 11, a reset module 12, a compensation control module 13, a storage module 14, and an illumination control module 15.

As shown in the figures, the data write module 11 can be coupled to a data signal terminal Data, a scan signal terminal Scan, and a first node A, respectively. The data write module 11 may be configured to provide a data signal supplied at the data signal terminal Data to the first node A under control of a scanning signal (also indicated by Scan) provided at the scan signal terminal Scan. The reset module 12 can be coupled to the reset signal terminal Reset, a reference signal terminal VREF, and the first node A, respectively. The reset module 12 can be configured to provide a reference signal (also indicated by VREF) provided at the reference signal terminal VREF to the first node A under control of the reset signal (also denoted by Reset).

The compensation control module 13 can be coupled to the scan signal terminal Scan, the control electrode m0 of the driving transistor DTFT, and the second pole m2 of the driving transistor DTFT, respectively. The compensation control module 13 may be configured to electrically communicate the control electrode m0 of the driving transistor DTFT and the second pole m2 of the driving transistor DTFT under control of the scanning signal Scan. Here, as shown in the figures, the first pole m1 of the driving transistor DTFT may be coupled to the first power supply terminal VDD.

The storage module 14 can be coupled to the first node A and the control electrode m0 of the driving transistor DTFT, respectively. The storage module 14 can be configured to be charged or discharged under control of the signal at the first node A and the signal at the control electrode m0 of the driving transistor DTFT. The storage module 14 may be configured to maintain the voltage difference between the first node A and the control electrode m0 of the driving transistor DTFT stable when the gate electrode m0 of the driving transistor DTFT is in a floating state.

The illumination control module 15 can be respectively coupled to an illumination control signal terminal EM, the reference signal terminal VREF, the first node A, the second pole m2 of the driving transistor DTFT, and the first terminal of the light-emitting device L. The second terminal of the light-emitting device L may be coupled to a second power supply terminal VSS. The illumination control module 15 may be configured to electrically connect the reference signal terminal VREF to the first node A and to electrically connect the second pole m2 of the driving transistor DTFT to the first terminal of the light-emitting device L, under control of the illumination control signal (also indicated by EM) provided at the illumination control signal terminal EM. Thereby, the driving transistor DTFT can drive the light-emitting device L to emit light.

According to the pixel driving circuit of the embodiment of the present disclosure, compensation for the threshold voltage of the driving transistor can be achieved, and the leakage current path with the initialization transistor can be avoided. Thereby, the brightness of the light-emitting device can be improved, and the flicker phenomenon at the time of displaying can be improved.

In the above pixel driving circuit provided by some embodiments of the present disclosure, as shown in FIG. 1, the driving transistor DTFT may be formed of P-type transistor. The gate of the P-type transistor is the control electrode m0 of the driving transistor DTFT, the source of the P-type transistor is the first pole m1 of the transistor DTFT, and the drain of the P-type transistor is the second pole m2 of the driving transistor DTFT. At this time, the operating current for driving the light-emitting device L to emit light flows from the source of the P-type transistor to the drain thereof.

In other embodiments, as shown in FIG. 2, the driving transistor DTFT may be formed of N-type transistor. The gate of the N-type transistor is the control electrode m0 of the driving transistor DTFT, the drain of the N-type transistor is the first pole m1 of the driving transistor DTFT, and the source of the N-type transistor is the second pole m2 of the driving transistor DTFT. At this time, the operating current for driving the light-emitting device L to emit light flows from the drain of the N-type transistor to its source.

In the pixel driving circuit of some embodiments of the present disclosure, as shown in FIG. 1, the initialization transistor M0 may be formed of a P-type transistor. Alternatively, as shown in FIG. 2, the initialization transistor M0 may be formed of an N-type transistor.

In some embodiments of the present disclosure, the leakage suppression module is further configured to: change the voltage difference between the control electrode of the initialization transistor and the second terminal of the initialization transistor, under control of the leakage control signal (i.e., third signal), such that the initialization transistor is further turned off.

In some more specific implementations, in the case where the initialization transistor is formed by P-type transistor, the leakage suppression module can be configured to: increase the voltage difference between the control electrode of the initialization transistor and the second pole of the initialization transistor, under control of the leakage control signal terminal. For example, the voltage difference can generally have a value greater than the threshold Vth of the P-type initialization transistor (Vth can typically be 0V or less than 0V) to turn off the P-type initialization transistor. Therefore, in the case where the threshold value of the P-type initialization transistor is about 0 V, the “increased voltage difference” may also refer to the absolute value of the voltage difference between the control electrode of the initialization transistor and the second pole of the initialization transistor being increased. As the voltage difference is increased, the degree of turning-off of the P-type initialization transistor is also increased.

In some embodiments of the present disclosure, the light-emitting device may generally be an organic electroluminescent diode. In some embodiments, the driving transistor can supply a current in a saturated operating state to drive the light-emitting device to emit light.

In some embodiments of the present disclosure, the voltage of the first power terminal may be set to be higher than the voltage of the second power terminal. For example, the voltage Vdd of the first power supply terminal can generally be a positive value, and the voltage Vss of the second power supply terminal can generally be ground or negative. In a practical application, the voltage Vdd of the first power supply terminal and the voltage Vss of the second power supply terminal may need to be determined according to the actual application environment, which is not limited herein.

In still other implementations, in the case where the initialization transistor is formed by N-type transistor, the leakage suppression module can be configured to: decrease the voltage difference between the control electrode of the initialization transistor and the second pole of the initialization transistor, under control of the leakage control signal terminal. For example, the voltage difference can generally have a value that is less than the threshold Vth of the N-type initialization transistor (Vth can generally be a value greater than 0V) to turn off the N-type initialization transistor. As the voltage difference is decreased, the degree at which the N-type initialization transistor is turned off is increased.

According to some embodiments of the present disclosure, the initialization transistor can be further turned off, thereby preventing the initialization transistor from forming a leakage current path, thereby the luminance of the light-emitting device can be improved, and the flicker phenomenon during displaying can be improved.

The present disclosure will be described in detail below with reference to more specific embodiments. It should be noted that the various embodiments or implementations described in the disclosure are illustrative and not for limiting purpose. Other embodiments can be readily obtained by one of ordinary skill in the art in view of the disclosure herein. The present disclosure is therefore not limited to the embodiments or implementations disclosed herein.

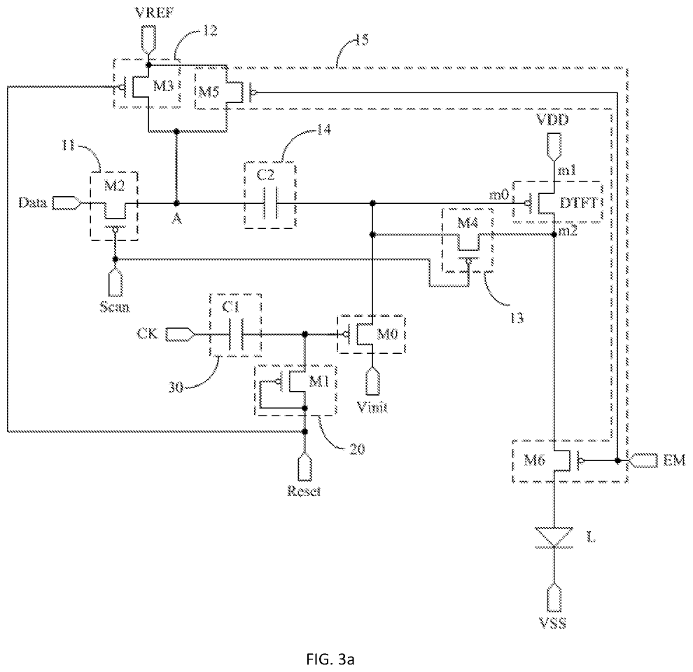

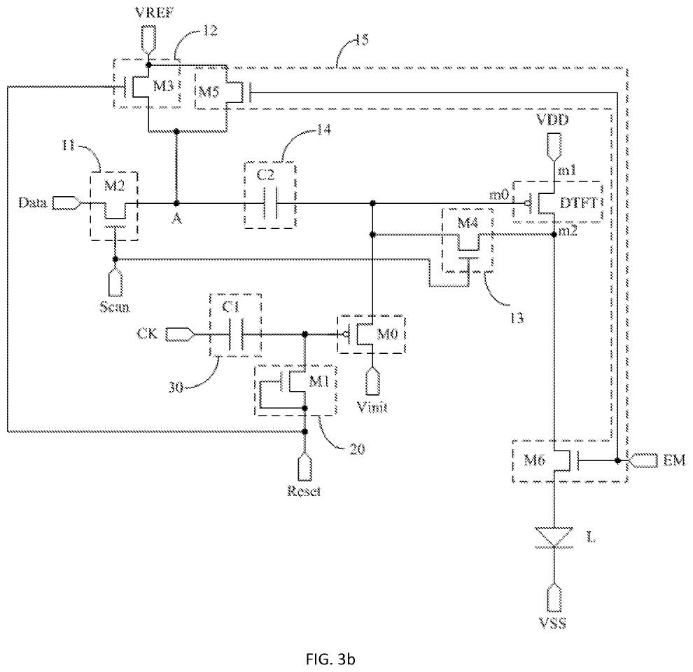

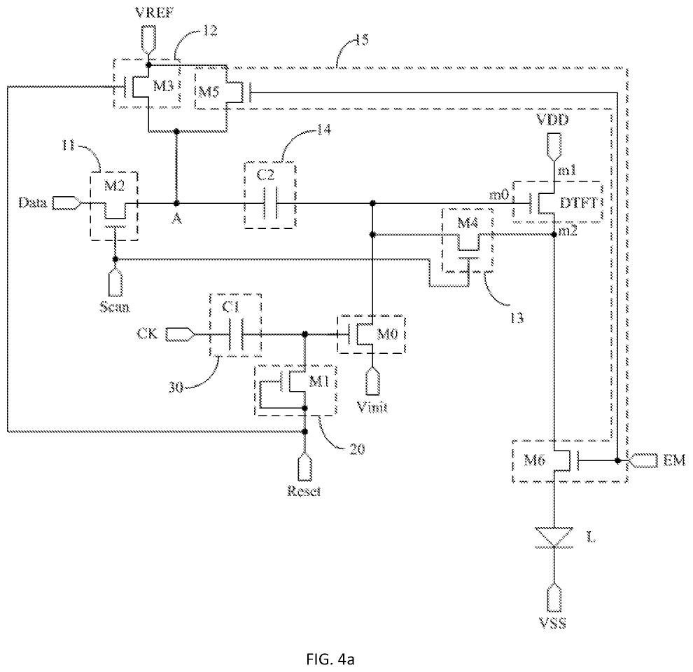

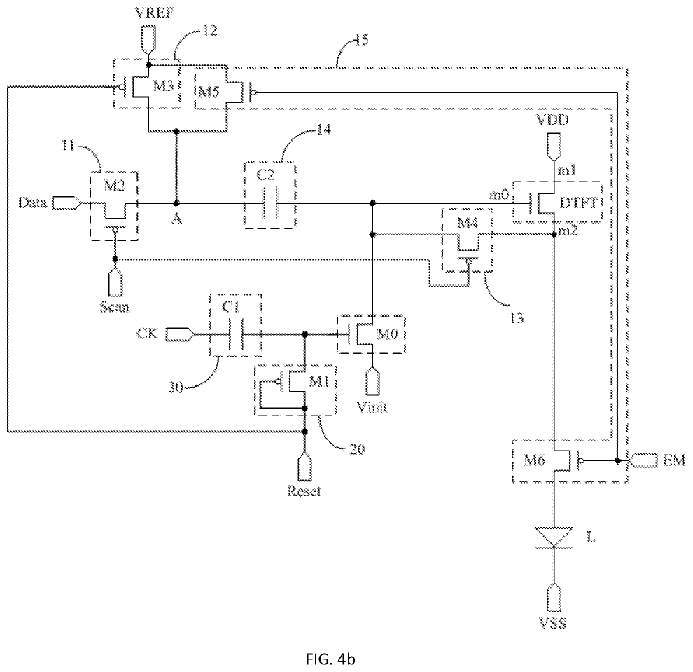

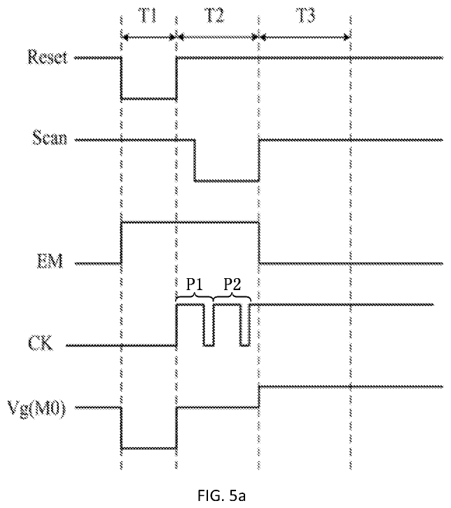

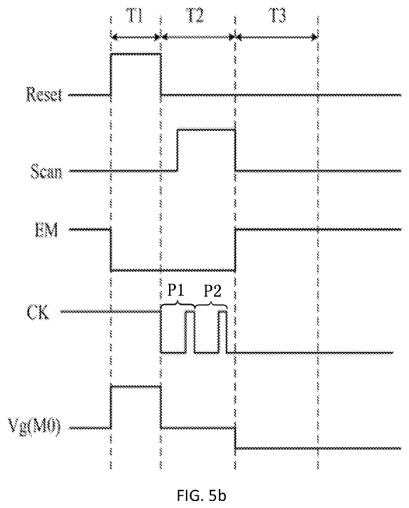

FIGS. 3a and 3b show detailed structural diagrams of a pixel driving circuit in accordance with some embodiments of the present disclosure. FIGS. 4a and 4b show detailed structural diagrams of a pixel driving circuit in accordance with some embodiments of the present disclosure. FIG. 5a is a timing chart schematically showing the operation of the pixel driving circuit shown in FIG. 3a. FIG. 5b is a timing chart schematically showing the operation of the pixel driving circuit shown in FIG. 4a. Description will be made below in conjunction with these drawings.

In some embodiments of the present disclosure, as shown in the figures, the signal input module 20 may include a first switch transistor M1. The control electrode and the first pole of the first switch transistor M1 are both coupled to the reset signal terminal Reset. The second pole of the first switch transistor M1 is coupled to the control electrode of the initialization transistor M0.

In some embodiments of the present disclosure, as shown in FIG. 3a and FIG. 4b, the first switch transistor M1 may be a P-type transistor; or, as shown in FIG. 3b and FIG. 4a, the first switch transistor M1 may be an N-type transistor.

In some embodiments of the present disclosure, when the first switch transistor is in an ON state under control of the reset signal, the reset signal provided by the reset signal terminal is supplied to the control electrode of the initialization transistor. For example, for the embodiment shown in FIG. 3a, when the reset signal Reset is logic low, the P-type transistor M1 is turned on, the reset signal Reset is supplied to the control electrode of the initialization transistor M0. And when the reset signal Reset is logic high, the P-type transistor M1 is turned off.

The first switch transistor can be formed on a substrate by multiple lithography processes. In some embodiments, the active layer of the first switch transistor can be formed of polysilicon (e.g., high resistance polysilicon).

In some embodiments of the present disclosure, as shown in FIG. 3a to FIG. 4b, the leakage suppression module 30 may specifically include a first capacitor C1. As shown in the figures, the first terminal of the first capacitor C1 may be coupled to the leakage control signal terminal CK to receive a leakage control signal (also indicated by CK), and the second terminal thereof may be coupled to the control electrode of the initialization transistor M0.

In some embodiments of the present disclosure, the leakage control signal CK may include a pulse signal. The pulse signal may include a high level period and a low level period in one pulse cycle. The leakage suppression module is configured to: charge the leakage suppression module by the high level period of the pulse signal, and discharge the leakage suppression module by the low level period of the pulse signal.

For example, in the embodiment shown in FIG. 3a, the reset signal at the reset signal terminal is active low (e.g., logic low). The low potential reset signal causes transistor M1 to be turned on, thereby causing a low potential reset signal to be supplied to the gate of initialization transistor M0. Thus, the initialization transistor M0 is in an ON state under control of the reset signal (low potential). In some implementations, the leakage control signal can be set to have two or more pulses. For example, if the voltage of the signal at the leakage control signal terminal which is at a high potential (for example, logic high) and the voltage of the reset signal terminal which is at a high potential are equal, the leakage control signal can be set to have a number of pulses, which is greater than or equal to 2, as shown in FIG. 5a. Alternatively, in other embodiments, the leakage control signal can be set to have one more pluses. For example, if the voltage of the leakage control signal at the leakage control signal terminal which is at a high potential is higher than the voltage of the reset signal terminal which is at a high potential, the leakage control signal can be set to have a number of pulses, which is greater than or equal to 1. the signal at the leakage control signal terminal can be designed according to the actual application. The direction and amplitude of voltage of the signal at the leakage control signal terminal which is at a high potential (for example, logic high) or at a low potential (e.g., logic low) can be designed according to requirements of the applications. Incidentally, the description is herein given with an example in which the high potential corresponds to logic high and the low potential corresponds to logic low; vise visa. The design can also be made on bases on reverse logic in which the high potential corresponds to logic low and the low potential corresponds to logic high.

For example, in the embodiment shown in FIG. 4a, the reset signal at the reset signal terminal is active high. The high potential reset signal causes transistor M1 to be turned on, thereby causing a high potential reset signal to be supplied to the gate of initialization transistor M0. Thus, the initialization transistor is in an ON state under control of the high potential signal at the reset signal terminal. Similarly, in some implementations, the leakage control signal can be set to have two or more pulses. For example, when the voltage of the signal of the leakage control signal terminal is low is equal to the voltage of the reset signal which is low, the number of pulses of the signal at the leakage control signal terminal can be set to be greater than or equal to 2, as shown in FIG. 5b. Alternatively, when the voltage of the signal at the leakage control signal terminal is lower than the voltage of the reset signal terminal which is at a low potential, the number of pulses of the signal at the leakage control signal terminal can be set to be greater than or equal to one. Similarly, the signal at the leakage control signal terminal can be designed according to the actual application.

In some embodiments of the present disclosure, the first capacitor is charged or discharged under control of the signal at the leakage control signal terminal (i.e., the leakage control signal). As shown in FIG. 5a, in the T2 phase, two pulse signals are provided in the leakage control signal. After the charging of the first capacitor (in the high-level period P1) is completed by the first pulse (assumed that the voltage difference between the two terminals is V₁ at this time), discharging is performed (in the low level period of the pulse signal P1), and the first capacitor is again charged when being not completely discharged. Since the first capacitor is not completely discharged after the first charging, the first capacitor has a certain voltage (or voltage difference) ΔV at the end of the low level period of the first pulse P1 of the CK signal. At this time, it is charged by the second pulse P2. When the first capacitor is recharged charged with V₁, the voltage difference across the first capacitor is V₁+ΔV according to the bootstrap action of the capacitor. Similarly to the first pulse P1, at the end of the low level discharging period of the second pulse P2, the first capacitance has a voltage difference of 2 ΔV. Thereafter, the first capacitor is charged again, and when the charging is completed, the first capacitor has a voltage difference of V₁+2 ΔV due to the bootstrap action.

In some embodiments of the present disclosure, the first capacitor may employ a CST structure. The CST structure includes three conductive layers and dielectric layers respectively disposed between each adjacent two conductive layers, that is, it is a structure obtained by connecting two capacitors in series. This makes the capacitance of the first capacitor larger and takes up less area. The CST structure may employ a CST structure known in the art or developed in the future. Detailed description thereof is omitted here.

In some embodiments of the present disclosure, as shown in FIG. 3a to FIG. 4b, the data write module 11 may specifically comprise a second switch transistor M2. The control electrode of the second switch transistor M2 is coupled to the scan signal terminal Scan, the first pole of the second switch transistor M2 is coupled to the data signal terminal Data, and the second pole of the second switch transistor M2 is coupled to the first node A.

In some embodiments of the present disclosure, as shown in FIG. 3a and FIG. 4b, the second switch transistor M2 may be a P-type transistor; or, as shown in FIG. 3b and FIG. 4a, the second switch transistor M2 may be an N-type transistor.

In some embodiments of the present disclosure, the second switch transistor may be in an ON state under control of the scan signal at the scan signal terminal, to provide a data signal (also indicated by Data) at the data signal terminal to the first node A.

In some embodiments of the present disclosure, as shown in FIG. 3a to FIG. 4b, the reset module 12 may specifically comprise a third switch transistor M3. The control electrode of the third switch transistor M3 is coupled to the reset signal terminal Reset, the first pole of the third switch transistor M2 is coupled to the reference signal terminal VREF, and the second pole of the third switch transistor M3 is coupled to the first node A.

In some embodiments of the present disclosure, as shown in FIG. 3a and FIG. 4b, the third switch transistor M3 may be a P-type transistor; or, as shown in FIG. 3b and FIG. 4a, the third switch transistor M3 may be an N-type transistor.

In some embodiments of the present disclosure, the third switch transistor may be in an ON state under control of the reset signal of the reset signal terminal, to provide the signal at the reference signal terminal to the first node.

In some embodiments of the present disclosure, as shown in FIG. 3a to FIG. 4b, the compensation control module 13 may specifically comprise a fourth switch transistor M4. The control electrode of the fourth switch transistor M4 is coupled to the scan signal terminal Scan, the first pole of the fourth switch transistor M4 is coupled to the control electrode m0 of the driving transistor DTFT, the second pole of the fourth switch transistor M4 is coupled to the second pole m2 of the driving transistor DTFT.

In some embodiments of the present disclosure, as shown in FIG. 3a and FIG. 4b, the fourth switch transistor M4 may be a P-type transistor; or, as shown in FIG. 3b and FIG. 4a, the fourth switch transistor M4 may also be an N-type transistor.

In some embodiments of the present disclosure, the fourth switch transistor may be in an ON state under control of the scan signal at the scan signal terminal to electrically connect the control electrode of the driving transistor to the second pole of the driving transistor. In this way, the driving transistor is in a diode-connected state, so that the signal at the first power supply terminal (for example, the power supply voltage) charges the control electrode of the driving transistor (or, the node to which the control electrode is coupled).

In some embodiments of the present disclosure, as shown in FIG. 3a to FIG. 4b, the illumination control module 15 may specifically comprise a fifth switch transistor M5 and a sixth switch transistor M6. The control electrode of the fifth switch transistor M5 is coupled to an illumination control signal terminal EM, the first pole of the fifth switch transistor M5 is coupled to the reference signal terminal VREF, and the second pole of the fifth switch transistor M5 is coupled to the first node A. The control electrode of the sixth switch transistor M6 is coupled to the illumination control signal terminal EM, the first pole of the sixth switch transistor M6 is coupled to the second pole m2 of the driving transistor DTFT, and the second pole of the sixth switch transistor M6 is coupled to the first terminal of the light-emitting device L.

In some embodiments of the present disclosure, as shown in FIG. 3a and FIG. 4b, the fifth switch transistor M5 and the sixth switch transistor M6 may be P-type transistors; or, as shown in FIG. 3b and FIG. 4a, the fifth switch transistor M5 an the sixth switch transistor M6 can also be an N-type transistor.

In some embodiments of the present disclosure, the fifth switch transistor may be in an ON state under control of the illumination control signal at the illumination control signal terminal to electrically connect the reference signal terminal to the first node, thereby providing the reference signal (VREF) of the reference signal terminal to the first node. When the sixth switch transistor is in an ON state under control of the illumination control signal, the second terminal of the driving transistor and the first terminal of the light-emitting device can be electrically coupled to provide a current at the second pole of the driving transistor to the light-emitting device, to drive the light-emitting device to emit light.

In some embodiments of the present disclosure, as shown in FIG. 3a to FIG. 4b, the storage module 14 may specifically comprise a second capacitor C2. The first terminal of the second capacitor C2 is coupled to the first node A, and the second terminal thereof is coupled to the control electrode m0 of the driving transistor M0.

In some embodiments of the present disclosure, the second capacitor is charged or discharged under control of a signal (or potential) at the first node and a signal (or potential) of the control electrode of the driving transistor. In addition, when the control electrode of the driving transistor is in the floating state, the second capacitor can keep the voltage difference between the first node and the control electrode of the driving transistor stable.

In some embodiments of the present disclosure, the second capacitor may employ a CST structure. This allows the second capacitor to occupy a smaller area. The CST structure can adopt the CST structures in the prior art, and thus is omitted from being described herein.

The foregoing is only for exemplifying the specific structures of the modules in the pixel driving circuit provided by some embodiments of the present disclosure. The structures of the modules shall not be limited to the above structures provided in the disclosure, and other structures known to those skilled in the art may also be used.

Further, in some embodiments of the present disclosure, as shown in FIG. 3a, all of the switch transistors in one or more of the above modules or components may be P-type transistors. Alternatively, as shown in FIG. 4a, all of the switch transistors in one or more of the above modules or components may be N-type transistors. It should be understood that the configurations shown in the figures are merely exemplary and the type of transistors can be set or selected as desired.

In some embodiments of the present disclosure, as shown in FIG. 3a, when the driving transistor DTFT is a P-type transistor, all of the switch transistors in one or more of the above modules or components may be provided as P-type transistors. Alternatively, as shown in FIG. 4a, when the driving transistor DTFT is an N-type transistor, all of the switch transistors in one or more of the above modules or components may be provided as N-type transistors. When all the switch transistors are provided in the same type as the driving transistor, the processes of the respective switch transistors in the pixel driving circuit can be unified, thus the fabrication process can be simplified.

In some embodiments of the present disclosure, the P-type transistor is configured to be turned off under a high potential and turned on at a low potential; the N-type transistor is configured to be turned on under a high potential and turned off at a low potential. It should be understood that the present disclosure is not limited thereto.

It should be noted that, in some embodiments of the present disclosure, the driving transistor, the initialization transistor, and each of the switch transistors may be thin film transistors (TFTs). In some embodiments of the present disclosure, the driving transistor, the initialization transistor, and each of the switch transistors may be metal oxide semiconductor (MOS) field effect transistors. However, the present disclosure is not limited thereto.

Those skilled in the art will readily appreciate that for a MOS transistor, its control electrode is the gate, its first pole can be its source or its drain, and its second pole can be the drain or the source. Here, in describing specific embodiments, descriptions are given with the example where the driving transistor and the switch transistor are MOS transistors.

The operations of some embodiments of the present disclosure will be further described below taking the pixel driving circuits shown in FIG. 3a and FIG. 4a as examples with reference to the timing diagrams. In the following description, logic 1 represents a high level and logic 0 represents a low level. It should be noted that said 1 and 0 are logic levels, which are only for better explaining the operations of some embodiments of the present disclosure, and do not represent the specific potential applied to the gates of the respective switch transistors.

FIG. 3a illustrates a detailed structural diagram of a pixel driving circuit in accordance with some embodiments of the present disclosure. FIG. 5a is a timing chart schematically showing the operation of the pixel driving circuit shown in FIG. 3a. As shown in FIG. 5a, one operation cycle of the pixel driving circuit may include, for example but not limited to, three phases including an initialization phase T1, a data write phase T2, and an light-emitting phase T3. Vg(M0) in FIG. 5a represents the gate voltage of the initialization transistor M0. As described above, in this embodiment, the driving transistor and each switch transistors are implemented with PMOS transistors. Further, in this embodiment, assume that the high potential voltage V_{ck} of the leakage control signal terminal CK is equal to the high potential voltage of the reset signal terminal Reset.

In the initialization phase T1, the reset signal Reset=0, the scan signal Scan=1, the illumination control signal EM=1, and the leakage control signal CK=0.

Since Reset=0, both the first switch transistor M1 and the third switch transistor M3 are turned on. Since Scan=1, both the second switch transistor M2 and the fourth switch transistor M4 are turned off. Since EM=1, both the fifth switch transistor M5 and the sixth switch transistor M6 are turned off. The turned-on first switch transistor M1 supplies a low potential signal (reset signal) at the reset signal terminal Reset to the gate of the initialization transistor M0 to turn on the initialization transistor M0. Thereby, the signal at the initialization signal terminal Vinit (initialization signal Vinit) is supplied to the gate of the driving transistor DTFT to initialize the gate voltage of the driving transistor DTFT, and thus the gate voltage of the driving transistor DTFT is Vᵢₙᵢₜ. Since the source voltage of the driving transistor DTFT is V_{dd}, the driving transistor DTFT can be in an ON state. However, since the sixth switch transistor M6 is turned off, the light-emitting device L does not emit light. The turned-on third switch transistor M3 supplies the signal (voltage V_{ref}) at the reference signal terminal VREF to the first node A, and thus the voltage of the first node A is V_{ref}. Since the gate voltage of the driving transistor DTFT is changed to Vᵢₙᵢₜ, the voltage of the second terminal of the second capacitor C2 (which is coupled to the gate of the driving transistor DTFT) is discharged from the voltage of the light-emitting phase in the previous display frame to Vᵢₙᵢₜ, so as to prepare for writing the signal at the data signal terminal Data d.

In the data write phase T2, Reset=1, Scan=0, EM=1.

Since Reset=1, both the first switch transistor M1 and the third switch transistor M3 are turned off. Since Scan=0, both the second switch transistor M2 and the fourth switch transistor M4 are turned on. Since EM=1, both the fifth switch transistor M5 and the sixth switch transistor M6 are turned off. The turned-on second switch transistor M2 supplies the data signal at the data signal terminal Data to the first node A. Therefore, the voltage of the first node A is V_{data}, and the second capacitor C2 is charged. The turned-on fourth switch transistor M4 can electrically connect the gate m0 of the driving transistor DTFT and the drain m2 of the driving transistor DTFT, thereby causing the driving transistor DTFT to form a diode-coupled state. Thus, the first power supply terminal VDD charges the gate m0 of the driving transistor DTFT through the driving transistor DTFT until the voltage of the gate m0 of the driving transistor DTFT becomes V_{dd}+|Vₜₕ|∘ Therefore, the voltage difference across the second capacitor C2 is: V_{dd}+|Vₜₕ|−V_{data}∘ The signal at the leakage control signal terminal CK includes two pulses in the data write phase T2. Here, the duty ratio in each pulse cycle is set to be greater than 50%. That is, here, in each pulse cycle, the duration of the low level period for discharging is smaller than the high level period for charging. During the first pulse (P1) period, the leakage control signal CK charges the first capacitor C1, causing the voltage difference across the capacitor C1 to become a high potential V_{ck}, thereby causing the gate of the initialization transistor M0 to be at a high potential to make it be turned off. Then, during the low level period of the first pulse P1, the first capacitor C1 is discharged. Since the duty ratio in each pulse cycle is greater than 50%, the first capacitor C1 is not completely discharged during the low level period of the first pulse P1. That is, when the first capacitor C1 also has the voltage ΔV, it enters the next pulse cycle, thereby the first capacitor C1 is charged again. During the cycle of the second pulse (P2) of the signal at the leakage control signal terminal CK, the charging and discharging process of the first capacitor C1 is repeated again.

In the light-emitting phase T3, Reset=1, Scan=1, EM=0, CK=1.

Since Reset=1, both the first switch transistor M1 and the third switch transistor M3 are turned off. Since Scan=1, both the second switch transistor M2 and the fourth switch transistor M4 are turned off. Since EM=0, both the fifth switch transistor M5 and the sixth switch transistor M6 are turned on. The turned-on fifth switch transistor M5 can connect the reference signal terminal VREF and the first node A, to supply the signal at the reference signal terminal VREF to the first node A, thus the voltage at the first node A becomes V_{ref}. At this time, since the transistor M0 is turned off, the gate m0 of the driving transistor DTFT is in a floating state. Due to the bootstrap action of the second capacitor C2, the voltage of the gate m0 of the driving transistor DTFT becomes: V_{ref}+V_{dd}+|Vₜₕ|−V_{data}, in order to maintain the voltage difference across to still be: V_{dd}+|Vₜₕ|−V_{data}. According to the saturation state current characteristic, the operating current I flowing through the driving transistor DTFT and for driving the coupled light-emitting device L to emit light satisfies the following equation: I=K(V_{gs}−|Vₜₕ|)²=K[V_{ref}+V_{dd}+|Vₜₕ|−V_{data}−V_{dd}−|Vₜₕ|]²=K[V_{ref}−V_{data}]²; wherein, V_{gs} is the gate-source voltage of the driving transistor DTFT; K is a structural parameter, which is relatively stable in the same structure and can be regarded as a constant. When the charging of the first capacitor C1 is completed at this phase, the voltage difference across the first capacitor C1 is V_{ck}+2ΔV, and the gate voltage Vg(M0) of the initialization transistor M0 can be V_{ck}+2ΔV.

The voltage of the drain of the initialization transistor (i.e., the second pole of the initialization transistor) is the gate voltage of the driving transistor. In some embodiments of the present disclosure, in the light-emitting phase, since the first capacitor can make the gate voltage of the initialization transistor be V_{ck}+2ΔV, as compared with the case where the gate voltage of the initialization transistor in the prior art is only the high voltage of the reset signal terminal (equivalent to V_{ck}), the voltage difference between the gate of the initialization transistor and its drain can be increased, thereby further increasing the off state of the initialization transistor. the leakage current in the initialization transistor can be further avoided from occurring. Thereby, leakage current path through the initialization transistor can be avoided. The brightness of the light-emitting device can be improved, and also the flicker can be improved.

It should be noted that, at the end of the data write phase, the charging of the first capacitor C1 may be completed or may be not completed, which can be set according to the actual application environment. In the embodiment shown in FIG. 5a, the gate voltage of the initialization transistor is shown to become V_{ck}+2 ΔV in the light-emitting phase in which the light-emitting device is driven to emit light, however, the present disclosure is not limited thereto. For example, the second pulse of the CK signal shown in FIG. 5a may be omitted in some embodiments, and instead a high potential is applied continuously. Alternatively, based on different elements or components used (for example, the different capacitance values), the gate voltage of the initialization transistor may be changed to V_{ck}+2 ΔV in the light-emitting phase or before the light-emitting phase.

From that the operation current I of the light-emitting phase satisfies the above equation, it can be seen that, the current when the driving transistor is in the saturation state is only related to the voltage V_{ref} of the reference signal terminal and the voltage V_{data} of the data signal terminal, and are not related to the threshold voltage Vₜₕ of the driving transistor and the voltage V_{dd} at the first power supply terminal. As such, according to the embodiments of the present disclosure, the drift of the threshold voltage Vₜₕ due to the process of the driving transistor and the long-time operation and the influence of the IR drop on the current flowing through the light-emitting device can be solved, thereby the operating current of the light-emitting device L is kept stable, thereby ensuring the normal operation of the light-emitting device L.

FIG. 4a illustrates a detailed structural diagram of a pixel driving circuit according to further embodiments of the present disclosure. FIG. 5b is a timing chart schematically showing the operation of the pixel driving circuit shown in FIG. 4a. FIG. 5b shows three phases including an initialization phase T1, a data write phase T2, and a light-emitting phase T3. Vg(M0) in FIG. 5b represents the gate voltage of the initialization transistor M0. As described above, in this embodiment, the driving transistor and the switch transistors are implemented with NMOS transistors. Further, in the present embodiment, assumed that the low potential voltage V_{ck} at the leakage control signal terminal CK is equal to the low potential voltage at the reset signal terminal Reset.

In the initialization phase T1, Reset=1, Scan=0, EM=0, CK=1.

Since Reset=1, both the first switch transistor M1 and the third switch transistor M3 are turned on. Since Scan=0, both the second switch transistor M2 and the fourth switch transistor M4 are turned off. Since EM=0, both the fifth switch transistor M5 and the sixth switch transistor M6 are turned off. The turned-on first switch transistor M1 supplies the high-potential signal at the reset signal terminal Reset to the gate of the initialization transistor M0, so that the initialization transistor M0 is turned on to supply the signal at the initialization signal terminal Vinit to the gate of the driving transistor DTFT to is initialize the gate voltage of the driving transistor DTFT. Therefore, the gate voltage of the driving transistor DTFT is Vᵢₙᵢₜ. Since the drain voltage of the driving transistor DTFT is V_{dd}, the driving transistor DTFT can be in an ON state. However, since the sixth switch transistor M6 is turned off, the light-emitting device L does not emit light. The turned-on third switch transistor M3 supplies the voltage V_{ref} of the signal at the reference signal terminal VREF to the first node A, so that the voltage of the first node A becomes V_{ref}. Since the gate voltage of the driving transistor DTFT is changed to Vᵢₙᵢₜ, the voltage of the second terminal of the second capacitor C2, which is coupled to the gate of the driving transistor DTFT, is discharged from the voltage of the light-emitting phase in the previous display frame to Vᵢₙᵢₜ, so as to prepare for the writing of the signal at the data signal terminal Data d.

In the data write phase T2, Reset=0, Scan=1, EM=0.

Since Reset=0, both the first switch transistor M1 and the third switch transistor M3 are turned off. Since Scan=1, both the second switch transistor M2 and the fourth switch transistor M4 are turned on. Since EM=0, both the fifth switch transistor M5 and the sixth switch transistor M6 are turned off. The turned-on second switch transistor M2 supplies the signal at the data signal terminal Data to the first node A, so that the voltage of the first node A becomes V_{data} and the second capacitor C2 is charged. The turned-on fourth switch transistor M4 can connect the gate m0 of the driving transistor DTFT and the source m2 of the driving transistor DTFT so that the driving transistor DTFT is in a diode-connected state. Thereby, the first power source VDD charges the gate m0 of the driving transistor DTFT through the driving transistor DTFT until the voltage of the gate m0 of the driving transistor DTFT becomes V_{dd}+|Vₜₕ|. Therefore, the voltage difference across the second capacitor C2 is: V_{dd}+|Vₜₕ|−V_{data}. The signal at the leakage control signal terminal CK includes two pulses in the data write phase T2 as shown in FIG. 5b. Here, the duty ratio in each pulse cycle is set to be less than 50%. That is, here, in each pulse cycle, the duration of the low level period for discharging is greater than the high level period for charging. In the first pulse (P1) cycle, during the low level period, the leakage control signal terminal CK discharges the first capacitor C1 to V_{ck}, so that the voltage difference across the capacitors C1 becomes the low potential V_{ck}, thereby controlling the gate of the initialization transistor M0 to be low to keep it off. Then, in the high level period, the first capacitor C1 is charged. Since the duty ratio is less than 50% in each pulse cycle, the first capacitor C1 is not fully charged during the high level period of the first pulse P1; that is, the first capacitor C1 enters the next pulse cycle with the voltage ΔV (which is a negative value relative to the CK signal) stored therein. Thereby the first capacitor C1 is discharged again. During the second pulse (P2) cycle of the signal at the leakage control signal terminal CK, the discharging and charging process of the first capacitor C1 is repeated again.

In the light-emitting phase T3, Reset=0, Scan=0, EM=1, CK=0.

Since Reset=0, both the first switch transistor M1 and the third switch transistor M3 are turned off. Since Scan=0, both the second switch transistor M2 and the fourth switch transistor M4 are turned off. Since EM=1, both the fifth switch transistor M5 and the sixth switch transistor M6 are turned on. The turned-on fifth switch transistor M5 can electrically connect the reference signal terminal VREF to the first node A to supply the voltage V_{ref} of the signal at the reference signal terminal VREF to the first node A, so that the voltage of the first node A becomes V_{ref}. Since the transistor M0 is turned off, the gate m0 of the driving transistor DTFT is in a floating state. Due to the bootstrap action of the second capacitor C2, the voltage of the gate m0 of the driving transistor DTFT becomes: V_{ref}+V_{dd}+|Vₜₕ|−V_{data}, in order to maintain the voltage difference between the two terminals to still be: V_{dd}+|Vₜₕ|−V_{data}. According to the saturation state current characteristic, the operating current I flowing through the driving transistor DTFT and for driving the coupled light-emitting device L to emit light satisfies the following equation: I=K(V_{gd}−|Vₜₕ|)²=K[V_{ref}+V_{dd}+|Vₜₕ|−V_{data}−V_{dd}−|Vₜₕ|]²=K[V_{ref}−V_{data}]², wherein, V_{gd} is the gate-drain voltage of the driving transistor DTFT; K is a structural parameter the value of which is relatively stable in the same structure, and can be regarded as a constant. When the charging of the first capacitor C1 is completed in this phase, the voltage difference across the first capacitor C1 is V_{ck}+2ΔV, and the gate voltage Vg(M0) of the initialization transistor M0 can be V_{ck}+2ΔV.

The voltage of the drain of the initialization transistor (i.e., the second pole of the initialization transistor) is the gate voltage of the driving transistor. In some embodiments of the present disclosure, in the light-emitting phase, since the first capacitor can make the gate voltage of the initialization transistor be V_{ck}+2ΔV, as compared with the gate voltage of the initialization transistor in the prior art which is only the high voltage V_{ck} of the reset signal terminal, the voltage difference between the gate and the drain of the initialization transistor can be reduced, so that the N-type initialization transistor is further turned off. The leakage current of the initialization transistor can be further suppressed from occurring, the leakage current through the initialization transistor can be prevented. The initialization transistor can be prevented from forming a leakage current path. The brightness of the light-emitting device can be improved, and the flicker can be improved.

From that the operating current I of the light-emitting phase satisfies the above equation, It can be seen that the current when the driving transistor is in the saturation state is only related to the voltage V_{ref} of the reference signal terminal and the voltage V_{data} of the data signal terminal, and is not related to the threshold voltage Vₜₕ of the driving transistor and the voltage V_{dd} of the first power supply terminal. According to the embodiments of the present disclosure, the drift the threshold voltage Vₜₕ due to the manufacturing processes of the driving transistor and the long-time operation, and the influence of the IR voltage drop on the current flowing through the light-emitting device can be solved, thereby the operating current of the light-emitting device L can be stabilized. Further, the normal operation of the light-emitting device L is ensured.

Similarly, at the end of the data write phase, the first capacitor C1 may be or may be not fully charged, which can be set according to the actual application. Although in the embodiment shown in FIG. 5b, the gate voltage of the initialization transistor is shown to become V_{ck}+2 ΔV in the light-emitting phase in which the light-emitting device is driven to emit light, the present disclosure is not limited thereto. For example, the second pulse of the CK signal shown in FIG. 5b may be omitted in some embodiments, and instead a low potential is continuously applied. Alternatively, depending on the different elements or components used (for example, the different capacitance values), the gate voltage of the initialization transistor may be changed to V_{ck}+2ΔV at the light-emitting phase or before the light-emitting phase.

In the above embodiment, the control electrode of the first switch transistor is coupled to its second pole to form a diode-connected state. The first switch transistor is turned on only in the initialization phase, and in the light-emitting phase, the first switch transistor is turned off. Thereby, in the light-emitting phase, the gate voltage of the initialization transistor can be controlled only by the first capacitance and the leakage control signal.

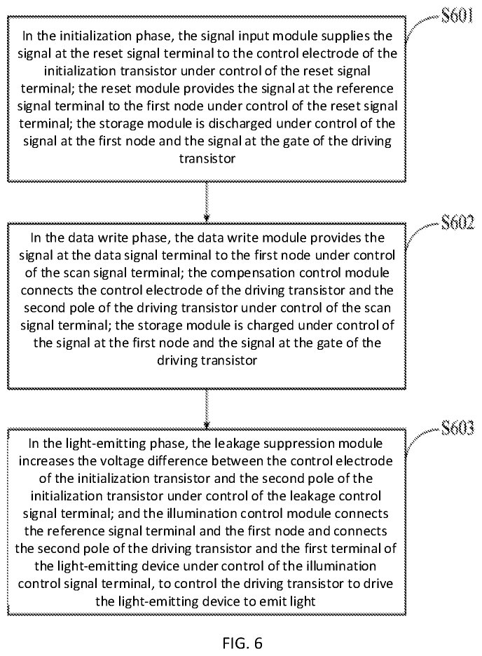

Some embodiments of the present disclosure also provide an operation method for any of the pixel driving circuits as illustrated in the accompanying drawings and described above, which, as shown in FIG. 6, includes: an initialization phase, a data write phase, and a light-emitting phase; wherein:

S601: In the initialization phase, the signal input module supplies the signal at the reset signal terminal to the control electrode of the initialization transistor under control of the reset signal terminal; the reset module provides the signal at the reference signal terminal to the first node under control of the reset signal terminal; the storage module is discharged under control of the signal at the first node and the signal at the gate of the driving transistor.

S602: In the data write phase, the data write module provides the signal at the data signal terminal to the first node under control of the scan signal terminal; the compensation control module connects the control electrode of the driving transistor and the second pole of the driving transistor under control of the scan signal terminal; the storage module is charged under control of the signal at the first node and the signal at the gate of the driving transistor.

S603: In the light-emitting phase, the leakage suppression module increases the voltage difference between the control electrode of the initialization transistor and the second pole of the initialization transistor under control of the leakage control signal terminal; and the illumination control module connects the reference signal terminal and the first node and connects the second pole of the driving transistor and the first terminal of the light-emitting device under control of the illumination control signal terminal, to control the driving transistor to drive the light-emitting device to emit light.

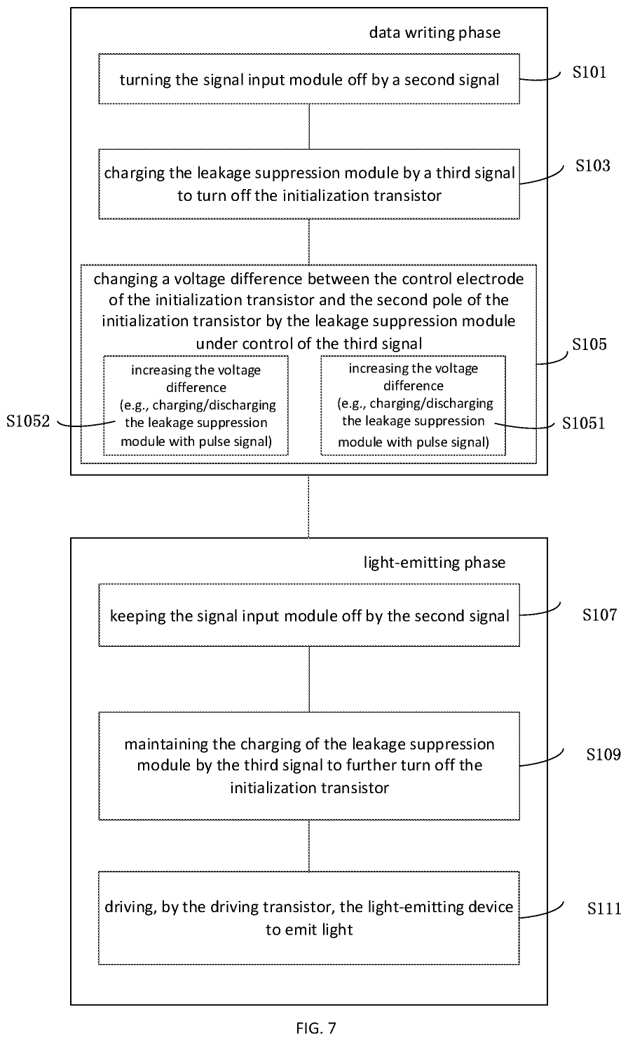

According to some embodiments of the present disclosure, there is also provided an operation method for a pixel driving circuit, as shown in FIG. 7. The method may comprise, in a data writing phase: configuring the reset signal to turn the signal input module off (step S101); charging the leakage suppression module by the leakage control signal to turn off the initialization transistor (step S103), and changing a voltage difference between the control electrode of the initialization transistor and the second pole of the initialization transistor by the leakage suppression module under control of the leakage control signal (step S105). The method may further comprise, in the light-emitting phase: keeping the signal input module off by the reset signal (step S107); maintaining the charging of the leakage suppression module by the leakage control signal to further turn off the initialization transistor (step S109); and driving, by the driving transistor, the light-emitting device to emit light (step S111).

In some implementations, the initialization transistor is formed of an N-type transistor, and the changing may comprise: reducing the voltage difference between the control electrode of the initialization transistor and the second pole of the initialization transistor (Step S1051). In some embodiments, the leakage control signal comprises a pulse signal including a high level period and a low level period in each pulse cycle thereof. In some embodiments, reducing the voltage difference may comprise charging the leakage suppression module by the high level period of the pulse signal, and discharging the leakage suppression module by the low level period of the pulse signal, wherein in the pulse cycle of the pulse signal, the duration of the low level period for discharging is less than the high level period for charging.

In some other implementations, the initialization transistor is formed of a P-type transistor, and wherein the changing may include: increasing the voltage difference between the control electrode of the initialization transistor and the second pole of the initialization transistor (Step S1052). In some embodiments, the leakage control signal includes a pulse signal, and each pulse cycle of the pulse signal includes a high level period and a low level period. In some embodiments, the increasing the voltage difference comprises: charging the leakage suppression module by the high level period of the pulse signal, and discharging the leakage suppression module by the low level period of the pulse signal, wherein in the pulse cycle, the duration of the low level period for discharging is greater than the high level period for charging.

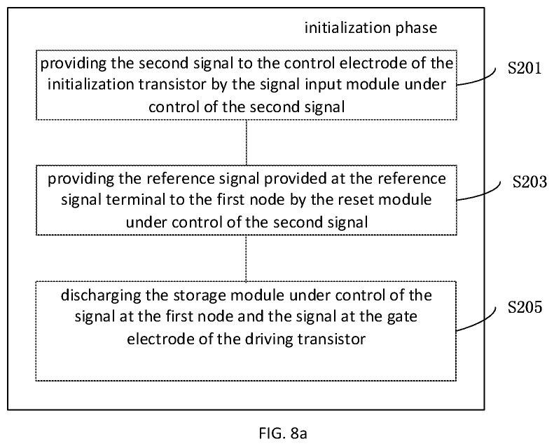

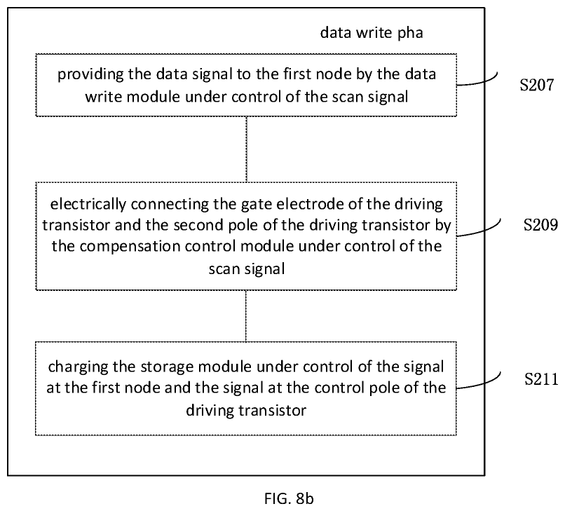

In some embodiments, the pixel compensation circuit further includes a data write module, a reset module, a compensation control module, a storage module, and an illumination control module. The data write module is respectively coupled to the data signal terminal, the scan signal terminal and the first node; the reset module is respectively coupled to the reset signal terminal, the reference signal terminal and the first node; the compensation control module respectively coupled to the scan signal terminal, the control electrode of the driving transistor, and the second pole of the driving transistor; the storage module is respectively coupled to the first node and the control electrode of the driving transistor; the illumination control module is respectively coupled to the illumination control signal terminal, the reference signal terminal, the first node, the second pole of the driving transistor, and the first terminal of the light-emitting device. The first pole of the driving transistor is coupled to the first power terminal. The method further comprises, as shown in FIG. 8a, in the initialization phase: providing the reset signal to the control electrode of the initialization transistor by the signal input module under control of the reset signal (step S201); providing the reference signal provided at the reference signal terminal to the first node by the reset module under control of the reset signal (step S203); and discharging the storage module under control of the signal at the first node and the signal at the gate electrode of the driving transistor (step S205).

The method may further include, as shown in FIG. 8b, in the data write phase: providing the data signal to the first node by the data write module under control of the scan signal (step S207); electrically connecting the gate electrode of the driving transistor and the second pole of the driving transistor by the compensation control module under control of the scan signal (step S209); and charging the storage module under control of the signal at the first node and the signal at the control pole of the driving transistor (step S211).

In some embodiments, the initialization signal may be an initialization signal, the reset signal may be a reset signal, and the third signal may be a leakage control signal.

According to the above driving method provided by the embodiments of the present disclosure, the compensation of the threshold voltage of the driving transistor can be realized, and the initialization transistor can be prevented from forming a leakage current path, thereby improving the brightness of the light-emitting device and improving the flicker phenomenon during display.

Some embodiments of the present disclosure also provide a display panel including: a light-emitting device, and a pixel driving circuit for driving the light-emitting device according to any of the embodiments of the present disclosure. The display panel may comprise an organic light-emitting display panel.

Some embodiments of the present disclosure also contemplate a display device including: a light-emitting device, and a pixel driving circuit for driving the light-emitting device according to any of the embodiments of the present disclosure. The above display panel can also be considered as a display device. In addition, the display device may comprise, but is not limited to, a mobile phone, a tablet computer, a television set, a display, a notebook computer, a digital photo frame, a navigator, and the like, or any product or component having a display function.

According to embodiments of the present disclosure, it is possible to prevent the initialization transistor from forming a leakage current path, thereby improving the luminance of the light-emitting device and improving the flicker phenomenon during display.

Further, it should be understood that the modules mentioned in the present disclosure can be implemented with circuits (or sub-circuits). Accordingly, various kinds of modules of the present disclosure may also be referred to as circuits or sub-circuits.

It will be apparent to those skilled in the art that various modifications and variations can be made in the present disclosure without departing from the spirit and scope of the disclosure. Thus, it is intended to embrace the modifications and variations in the scope of present disclosure if these modifications and changes fall within the scope of the claims and the equivalent thereof.

1. A pixel driving circuit comprising:
a pixel compensation circuit comprising a driving transistor for driving a light-emitting device in a pixel and an initialization transistor, a first pole of the initialization transistor being coupled to an initialization signal terminal for receiving an initialization signal, a second pole of the initialization transistor being coupled to a control electrode of the driving transistor;
a signal input sub-circuit coupled between a reset signal terminal and a control electrode of the initialization transistor, for selectively providing a reset signal, which is received from the reset signal terminal, to the control electrode of the initialization transistor under control of the reset signal;
a leakage suppression sub-circuit respectively coupled to a leakage control signal terminal and the control electrode of the initialization transistor, the leakage suppression sub-circuit being configured so that:
the leakage suppression sub-circuit is charged or discharged by a leakage control signal received from the leakage control signal terminal, and the initialization transistor is turned off by the charging or discharging.

2. The pixel driving circuit of claim 1, wherein the leakage suppression sub-circuit is further configured to:
changing a voltage difference between the control electrode of the initialization transistor and the second pole of the initialization transistor under control of the leakage control signal to cause the initialization transistor to be further turned off.

3. The pixel driving circuit of claim 2,
wherein the initialization transistor is an N-type transistor, and
wherein the changing comprises: reducing the voltage difference between the control electrode of the initialization transistor and the second pole of the initialization transistor.

4. The pixel driving circuit of claim 2,
wherein the initialization transistor is a P-type transistor, and
wherein the changing comprises increasing the voltage difference between the control electrode of the initialization transistor and the second pole of the initialization transistor.

5. The pixel driving circuit of claim 3,
wherein the leakage control signal comprises a pulse signal including a high level period and a low level period in each pulse cycle of the pulse signal;
wherein the leakage suppression sub-circuit is configured to:
charge the leakage suppression sub-circuit by the high level period of the pulse signal, and
discharge the leakage suppression sub-circuit by the low level period of the pulse signal,
wherein in the pulse cycle, a duration of the low level period for discharging is less than that of the high level period for charging.

6. The pixel driving circuit of claim 4,
wherein the leakage control signal comprises a pulse signal including a high level period and a low level period in each pulse cycle of the pulse signal;
wherein the leakage suppression sub-circuit is configured to:
charge the leakage suppression sub-circuit by the high level period of the pulse signal, and
discharge the leakage suppression sub-circuit by the low level period of the pulse signal,
wherein in the pulse cycle, a duration of the low level period for discharging is greater than that of the high level period for charging.

7. The pixel driving circuit of claim 1, wherein the signal input sub-circuit comprises:
a first switch transistor, wherein a control electrode and a first pole of the first switch transistor are both coupled to the reset signal terminal, and a second pole of the first switch transistor is coupled to the control electrode of the initialization transistor.

8. (canceled)

9. The pixel driving circuit of claim 1, wherein the leakage suppression sub-circuit comprises:
a first capacitor, wherein the first capacitor has a first terminal coupled to the leakage control signal terminal and a second terminal coupled to the control electrode of the initialization transistor.

10. The pixel driving circuit according to claim 1,
wherein the pixel compensation circuit further comprises a data write sub-circuit, a reset sub-circuit, a compensation control sub-circuit, a storage sub-circuit, and an illumination control sub-circuit;
wherein the first pole of the driving transistor is coupled to a first power terminal;
wherein the data write sub-circuit is respectively coupled to a data signal terminal, a scan signal terminal and a first node, for providing a data signal provided at the data signal terminal to the first node under control of a scanning signal provided at the scan signal terminal;
wherein the reset sub-circuit is respectively coupled to the reset signal terminal, a reference signal terminal, and the first node, for providing a reference signal provided at the reference signal terminal to the first node under control of the reset signal;
wherein the compensation control sub-circuit is respectively coupled to the scan signal terminal, the control electrode of the driving transistor, and a second pole of the driving transistor, for electrically coupling the control electrode of the driving transistor to the second pole of the driving transistor under control of the scanning signal;
wherein the storage sub-circuit is respectively coupled to the first node and the control electrode of the driving transistor, for being charged or discharged under control of a signal at the first node and a signal at the control electrode of the driving transistor and maintaining a voltage difference between the first node and the control electrode of the driving transistor stable when the control electrode of the driving transistor is in a floating state; and
wherein the illumination control sub-circuit is respectively coupled to an illumination control signal terminal, the reference signal terminal, the first node, the second pole of the driving transistor, and a first terminal of the light-emitting device, for under control of an illumination control signal provided at the illumination control signal terminal, electrically connecting the reference signal terminal to the first node and electrically connecting the second pole of the driving transistor and the first terminal of the light-emitting device such that the driving transistor is capable of driving the light-emitting device to emit light.

11. The pixel driving circuit of claim 10,
wherein the data write sub-circuit comprises a second switch transistor having a control electrode coupled to the scan signal terminal, a first pole coupled to the data signal terminal, and a second pole coupled to the first node;
wherein the reset sub-circuit comprising a third switch transistor having a control electrode coupled to the reset signal terminal, a first pole coupled to the reference signal terminal, and a second pole coupled to the first node;
wherein the compensation control sub-circuit comprises a fourth switch transistor having a control electrode coupled to the scan signal terminal, a first pole coupled to the control electrode of the driving transistor, and a second pole coupled to the second pole of the driving transistor;
wherein the storage sub-circuit comprises a second capacitor having a first terminal coupled to the first node and a second terminal coupled to a control pole of the driving transistor; and
wherein the illumination control sub-circuit comprises a fifth switch transistor and a sixth switch transistor; wherein a control electrode of the fifth switch transistor is coupled to the illumination control signal terminal, a first pole of the fifth switch transistor coupled to the reference signal terminal, and a second pole of the fifth switch transistor is coupled to the first node; a control pole of the sixth switch transistor is coupled to the illumination control signal terminal, a first pole of the sixth switch transistor is coupled to the second pole of the driving transistor, and a second pole of the sixth switch transistor is coupled to the first terminal of the light-emitting device.

12. The pixel driving circuit of claim 1 wherein:
where the driving transistor is a P-type transistor, each switch transistor in one or more of the data write sub-circuit, the reset sub-circuit, the compensation control sub-circuit, the storage sub-circuit, and the illumination control sub-circuit is configured by a P-type transistor.

13. The pixel driving circuit of claim 1 wherein:
where the driving transistor is an N-type transistor, each switch transistor in one or more of the data write sub-circuit, the reset sub-circuit, the compensation control sub-circuit, the storage sub-circuit, and the illumination control sub-circuit It is configured by an N-type transistor.

14. A display device comprising:
a light-emitting device, and
a pixel driving circuit according to claim 1 for driving the light-emitting device.

15. An operating method for a pixel driving circuit according to claim 1, the method comprising:
in a data writing phase,
configuring the reset signal to turn the signal input sub-circuit off,
charging the leakage suppression sub-circuit by the leakage control signal to turn off the initialization transistor, and
changing a voltage difference between the control electrode of the initialization transistor and the second pole of the initialization transistor by the leakage suppression sub-circuit under control of the leakage control signal;
in a light-emitting phase,
keeping the signal input sub-circuit off by the reset signal,
maintaining the charging of the leakage suppression sub-circuit by the leakage control signal to further turn off the initialization transistor; and
driving, by the driving transistor, the light-emitting device to emit light.

16. The method of claim 15, wherein
the initialization transistor is an N-type transistor, and
the changing comprises: reducing the voltage difference between the control electrode of the initialization transistor and the second pole of the initialization transistor.

17. The method of claim 15, wherein
the initialization transistor is a P-type transistor, and
the changing comprises: increasing the voltage difference between the control electrode of the initialization transistor and the second pole of the initialization transistor.

18. The method of claim 16, wherein
the leakage control signal comprises a pulse signal including a high level period and a low level period in each pulse cycle of the pulse signal;
wherein reducing the voltage difference comprises:
charging the leakage suppression sub-circuit by the high level period of the pulse signal, and
discharging the leakage suppression sub-circuit by the low level period of the pulse signal,
wherein in the pulse cycle, a duration of the low level period for discharging is less than the high level period for charging.

19. The method of claim 17, wherein
the leakage control signal comprises a pulse signal including a high level period and a low level period in each pulse cycle of the pulse signal;
wherein increasing the voltage difference comprises:
charging the leakage suppression sub-circuit by the high level period of the pulse signal, and
discharging the leakage suppression sub-circuit by the low level period of the pulse signal,
wherein in the pulse cycle, a duration of the low level period for discharging is greater than the high level period for charging.

20. The method of claim 15, wherein
the pixel compensation circuit further comprises a data write sub-circuit, a reset sub-circuit, a compensation control sub-circuit, a storage sub-circuit, and an illumination control sub-circuit;
the first pole of the driving transistor is coupled to a first power terminal;
the data write sub-circuit is respectively coupled to a data signal terminal, a scan signal terminal and a first node;
the reset sub-circuit is respectively coupled to the reset signal terminal, a reference signal terminal, and the first node;
the compensation control sub-circuit is respectively coupled to the scan signal terminal, the control electrode of the driving transistor, and the second pole of the driving transistor;
the storage sub-circuit is respectively coupled to the first node and the control electrode of the driving transistor;
the light-emitting control sub-circuit is respectively coupled to a light-emitting control signal terminal, the reference signal terminal, the first node, and the second pole of the driving transistor, and a first terminal of the light-emitting device,
the method further comprises:
in an initialization phase,
providing the reset signal to the control electrode of the initialization transistor by the signal input sub-circuit under control of the reset signal;
providing a reference signal provided at the reference signal terminal to the first node by the reset sub-circuit under control of the reset signal; and
discharging the storage sub-circuit under control of a signal at the first node and a signal at the control electrode of the driving transistor.

21. The method of claim 20, further comprising:
in the data writing phase,
providing the data signal to the first node by the data write sub-circuit under control of the scan signal;
electrically connecting the control electrode of the driving transistor and the second pole of the driving transistor by the compensation control sub-circuit under control of the scan signal; and
charging the storage sub-circuit under control of the signal at the first node and the signal at the control pole of the driving transistor.
